(19) United States
(12) Patent Application Publication
(10) Pub. No.: US 2025/0037631 A1
(43) Pub. Date: Jan. 30, 2025

(54) LOW-POWER DISPLAY MECHANISM APPLIED TO LOW-ENERGY-STORAGE DEVICE

(71) Applicant: Jianhui Wu, Leping (CN)

(72) Inventors: Jianhui Wu, Leping (CN); Yuan Wang, Leping (CN); Yuanwei Wang, Leping (CN)

(21) Appl. No.: 18/916,243

(22) Filed: Oct. 15, 2024

(30) Foreign Application Priority Data
Sep. 13, 2024 (CN) 202422249540.5

(51) Int. Cl. G09G 3/00; G02F 1/167; G09G 3/34

(52) U.S. Cl. CPC G09G 3/035; G02F 1/167; G09G 3/3446; G09G 2300/0473; G09G 2300/08; G09G 2310/0256; G09G 2330/023; G09G 2354/00

(57) ABSTRACT

The present disclosure discloses a low-power display mechanism applied to a low-energy-storage device, comprising a circuit board assembly, a storage battery, and a low-power display screen. The low-power display screen comprises a top transparent electrode layer, a color developing particle layer, and a bottom electrode layer. In the present disclosure, the low-power display screen only consumes electricity when changing display content, and the display content can be maintained for long time and will not disappear even if there is a power outage. Furthermore, the display content can be clear and visible under strong light. The design significantly reduces the energy consumption by reducing the frequency of applying an electric field, and is suitable for being used in various low-energy-storage devices.

### TECHNICAL FIELD

The present disclosure relates to the technical field of smart equipment, and particularly, to a low-power display mechanism applied to a low-energy-storage device.

### BACKGROUND

With the development of Internet technologies and smart products, a variety of smart wearable products have appeared on the market. All kinds of smart wearable products are used to achieve various detection and monitoring functions, and are combined with the Internet to achieve intelligence. Unlike a traditional ring, a smart ring has different electronic functions and can be flexibly designed in its form according to a need. The common smart ring integrates a flexible printed circuit board and various kinds of sensors inside the ring, which can monitor various physical data of a human body through the sensors. The function of the smart ring is very powerful. However, since the smart ring is worn on a finger of a user during use, a space of a body of the smart ring is extremely limited, which requires electrical components inside the body to be integrated and reduced as much as possible. Only low-energy-storage small batteries can be used as storage batteries.

However, when satisfying its battery life, the low-energy-storage battery has no more redundant power available for high-power devices. Therefore, it is difficult to see smart rings with display screens among current products on the market. The reason is that a traditional display screen device consumes too much power, and the low-energy-storage battery of the smart ring cannot meet a usage requirement. However, without a display screen, many prompt functions cannot be intuitively reflected in the smart ring itself, but they need to be read through matching APP clients, which greatly brings inconvenience to users.

### SUMMARY

The present disclosure aims to provide a low-power display mechanism applied to a low-energy-storage device. Applying the display mechanism to the low-energy-storage device can synchronously achieve a display function without affecting the normal battery life of the device. The problems mentioned in the background section are solved.

To achieve the above objectives, the present disclosure provides the following technical solution: A low-power display mechanism applied to a low-energy-storage device includes a circuit board assembly, a storage battery, and a low-power display screen; the storage battery and the low-power display screen are both electrically connected to the circuit board assembly; the low-power display screen includes a top transparent electrode layer, a color developing particle layer, and a bottom electrode layer; the color developing particle layer is sandwiched between the top transparent electrode layer and the bottom electrode layer; the color developing particle layer is provided with a plurality of color developing particles; the color developing particles have own charges; the color developing particles comprise positive-charge color developing particles and negative-charge color developing particles; colors between the positive-charge color developing particles and the negative-charge color developing particles are different; and when an electric field is applied to a sandwich region between the top transparent electrode layer and the bottom electrode layer, the color developing particles are driven by the electric field to be transferred towards an opposite electric field direction corresponding to the color developing particles.

Preferably, liquid with a hysteresis effect is packaged in the color developing particle layer, and the color developing particles are suspended in the liquid of the color developing particle layer.

Preferably, the color developing particle layer is filled with a plurality of particle casings; the color developing particles are wrapped by the particle casings; the positive-charge color developing particles and the negative charge color developing particles coexist in the particle casings; liquid with a hysteresis effect is packaged in the particle casings; and the positive-charge color developing particles and the negative charge color developing particles are suspended in the liquid in the particle casings.

Preferably, the particle casings are transparent casings.

Preferably, the color developing particles are formed by integrally connecting the positive-charge color developing particles to the negative-charge color developing particles; one side of each color developing particle is the positive-charge color developing particle, and the opposite side is the negative-charge color developing particle; liquid with a hysteresis effect is packaged in the color developing particle layer; and the color developing particles are suspended in the liquid of the color developing particle layer.

Preferably, the transparent liquid has a bistable characteristic, i.e. a hysteresis effect.

Preferably, the bottom electrode layer is a segment code electrode layer; the segment code electrode layer is composed of a plurality of electrodes arranged in pre-defined segments to form display content; and each segmented electrode is independently controlled.

Preferably, the bottom electrode layer is a dot matrix electrode layer; the dot matrix electrode layer includes a thin film transistor (TFT) substrate layer for supporting and a thin film transistor layer that covers the TFT substrate layer; a plurality of pixel electrodes are arranged in a dot matrix on the TFT substrate layer; a transistor is correspondingly connected to each pixel electrode; and display content is formed by controlling a transistor dot matrix.

Preferably, the low-energy-storage device is a smart ring; the smart ring comprises a shell; the shell is provided with a perspective window; the low-power display screen is arranged at the perspective window; the circuit board assembly and the storage battery are arranged on an inner side of the shell; the circuit board assembly comprises a flexible printed circuit board; and the flexible printed circuit board is packaged with a charging interface and an electronic component.

Preferably, a potting adhesive layer is arranged on an inner side of the shell; the circuit board assembly, the storage battery, and the low-power display screen are all packaged in the potting adhesive layer; and the charging interface extends out of the potting adhesive layer.

Compared with the prior art, the present disclosure has the beneficial effects below:

In the present disclosure, the low-power display screen only consumes electricity when changing display content, and the display content can be maintained for long time and will not disappear even if there is a power outage. Furthermore, the display content can be clear and visible under strong light. The design significantly reduces the energy consumption by reducing the frequency of applying an electric field, and is suitable for being used in various low-energy-storage devices.

### BRIEF DESCRIPTION OF THE DRAWINGS

FIG. 1 is a structural exploded diagram of application to a smart ring according to the present disclosure;

FIG. 2 is a structural diagram of an appearance of application to a smart ring according to the present disclosure;

FIG. 3 is a schematic structural diagram of a low-power display screen according to the present disclosure;

FIG. 4 is a schematic diagram of a form showing that color developing particles are wrapped in particle casings according to the present disclosure;

FIG. 5 is a schematic diagram of a pattern style of application of a segment code electrode layer to a bottom electrode layer according to the present disclosure; and

FIG. 6 is a schematic diagram of a pattern style of application of a dot matrix electrode layer to a bottom electrode layer according to the present disclosure.

In the drawings: 1: shell; 11: perspective window; 2: potting adhesive layer; 3: circuit board assembly; 31: flexible printed circuit board; 32: charging interface; 33: electronic component; 4: storage battery; 5: low-power display screen; 51: top transparent electrode layer; 52: color developing particle layer; 53: bottom electrode layer; 54: positive-charge color developing particle; 55: negative-charge color developing particle; 56: particle casing; and 6: electrode.

### DETAILED DESCRIPTION OF THE EMBODIMENTS

The technical solutions in the embodiments of the present disclosure are clearly and completely described below with reference to the accompanying drawings in the embodiments of the present disclosure. Apparently, the described embodiments are merely some embodiments of the present disclosure, rather than all the embodiments. All other embodiments obtained by a person of ordinary skill in the art based on the embodiments of the present disclosure without making creative efforts shall fall within the protection scope of the present disclosure.

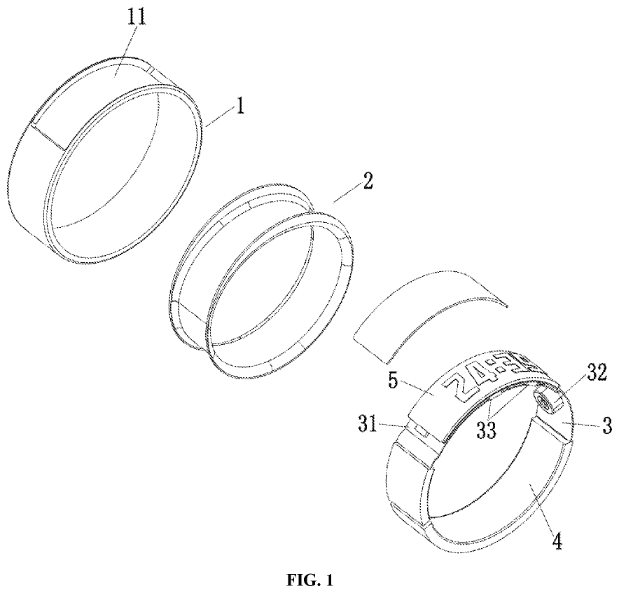

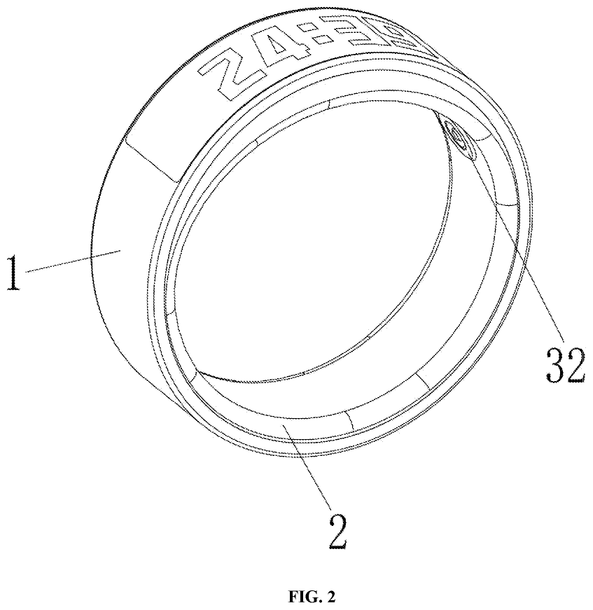

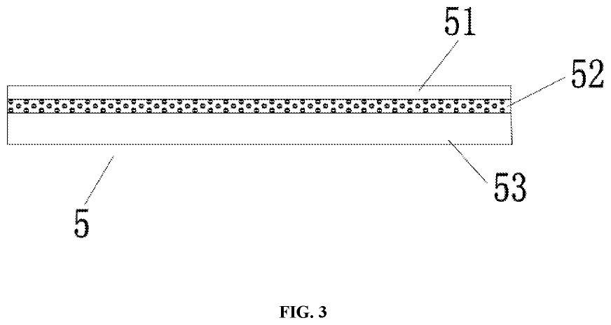

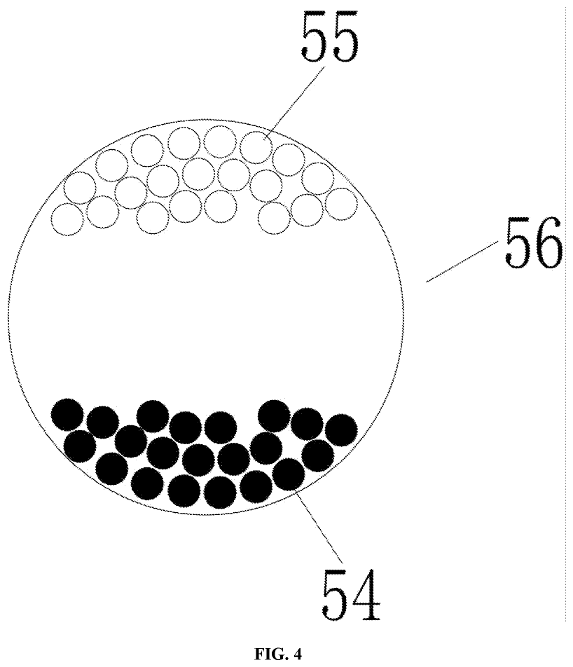

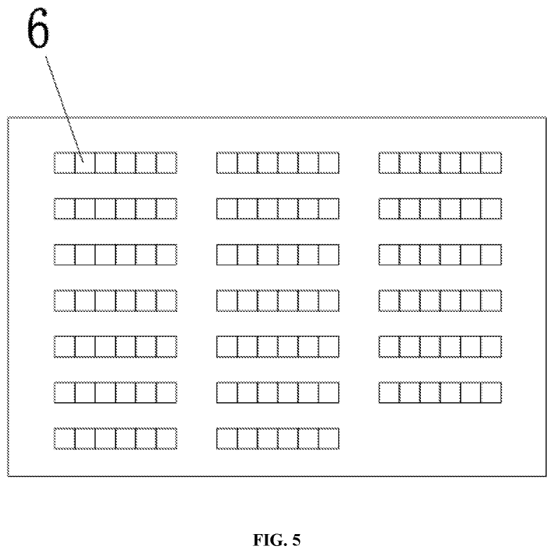

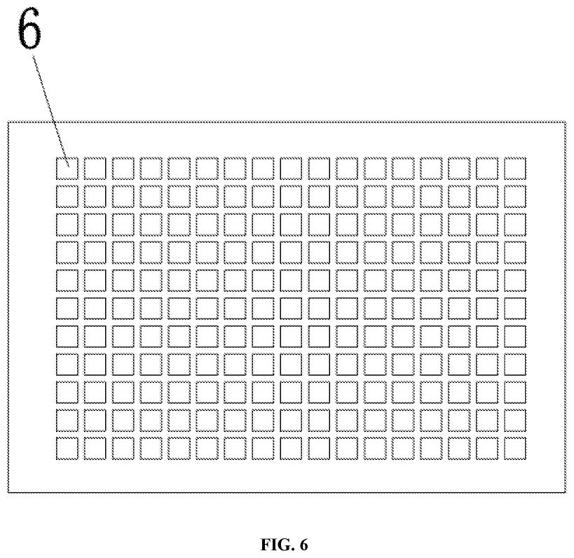

Referring to FIG. 1 to FIG. 6, a low-power display mechanism applied to a low-energy-storage device includes a circuit board assembly 3, a storage battery 4, and a low-power display screen 5. The storage battery 4 and the low-power display screen 5 are both electrically connected to the circuit board assembly 3. The low-power display screen 5 includes a top transparent electrode layer 51, a color developing particle layer 52, and a bottom electrode layer 53. The color developing particle layer 52 is sandwiched between the top transparent electrode layer 51 and the bottom electrode layer 53. The top transparent electrode layer 51 is usually made of a transparent conductive material such as indium tin oxide (ITO) and serves as a common electrode, which covers an entire display region. The bottom electrode layer 53 uses a segment code electrode layer. The segment code electrode layer is composed of a plurality of electrodes 6 arranged in pre-defined segments to form display content; and each segmented electrode 6 is independently controlled. When the segment code electrode layer is used, the resolution of the display content is determined by a quantity of predefined segments, which is usually a lower resolution. Additionally, due to a limited number of control units, the power consumption of the segment code electrode layer is also low. The bottom electrode layer 53 may also use a dot matrix electrode layer. The dot matrix electrode layer includes a TFT substrate layer for supporting and a thin film transistor layer that covers the TFT substrate layer. A plurality of pixel electrodes 6 are arranged in a dot matrix on the TFT substrate layer. A transistor is correspondingly connected to each pixel electrode 6. Display content is formed by controlling a transistor dot matrix. The resolution of the dot matrix electrode layer can be very high, depending on the density of the pixel electrodes 6. Meanwhile, compared with the segment code electrode layer, the dot matrix electrode layer has high power consumption. The bottom electrode layer 53 may be a hard pad layer or a soft pad layer. If the soft pad layer is used, the low-power display screen 5 can be applied to various curved display regions, thereby improving the applicability of the low-power display screen. The color developing particle layer 52 is provided with a plurality of color developing particles; the color developing particles have own charges; the color developing particles include positive-charge color developing particles 54 and negative-charge color developing particles 55; colors between the positive-charge color developing particles 54 and the negative-charge color developing particles 55 are different; and when an electric field is applied to a sandwich region between the top transparent electrode layer 51 and the bottom electrode layer 53, the color developing particles are driven by the electric field to be transferred towards an opposite electric field direction corresponding to the color developing particles. Under the driving of a control chip arranged in the circuit board assembly 3, the top transparent electrode layer 51 and the bottom electrode layer 53 can form a patterned electric field that is the same as a pattern of the display content. The color developing particles are aggregated under the guidance of the patterned electric field to form target display content and are displayed to a user through the top transparent electrode layer 51. Specifically, in display equipment, if content needs to be displayed, by controlling an electric field between the upper layer of transparent electrodes and the lower layer of electrodes, the color developing particles move to corresponding positions under the action of the electric field, thereby forming a desired image or text. If the electric field is turned off or the power is cut off, the color developing particles maintain their positions unchanged under the hysteresis effect of liquid, so the display content will not disappear. Even if the equipment is powered off, the content will still be read. The content will not change until the electric field is applied next time.

In Embodiment I, the color developing particle layer 52 is filled with transparent liquid. The color developing particles are suspended in the transparent liquid of the color developing particle layer 52. If the top transparent electrode layer 51 is positively charged and the bottom electrode layer 53 is negatively charged, the positive-charge color developing particles 54 are white, and the negative-charge color developing particles 55 are black. At this time, the black particles will float up and the white particles will sink, thereby forming black display content at the top transparent electrode layer 51. On the contrary, if the top transparent electrode layer 51 is negatively charged and the bottom electrode layer 53 is positively charged, the white particles will float up and the black particles will sink, thereby forming white display content at the top transparent electrode layer 51.

Due to the bistable characteristic, i.e. the hysteresis effect, of the transparent liquid, when the electric field between the top transparent electrode layer 51 and the bottom electrode layer 53 disappears, the color developing particles will also remain suspended at the positions at the moment of disappearance of the electric field. Therefore, the display content seen via the top transparent electrode layer 51 will also remain unchanged.

In Embodiment II, the color developing particle layer 52 is filled with a plurality of particle casings 56. The particle casings 56 are transparent casings. The color developing particles are wrapped by the particle casings 56. The positive-charge color developing particles 54 and the negative charge color developing particles 55 coexist in the particle casings 56. The positive-charge color developing particles 54 and the negative charge color developing particles 55 are suspended in the transparent liquid in the particle casings 56.

If the top transparent electrode layer 51 is positively charged and the bottom electrode layer 53 is negatively charged, the positive-charge color developing particles 54 are white, and the negative-charge color developing particles 55 are black. At this time, the black particles will float up and be gathered at upper ends of the particle casings 56, and the white particles will sink and be gathered at lower ends of the particle casings 56, thereby forming black display content at the top transparent electrode layer 51. On the contrary, if the top transparent electrode layer 51 is negatively charged, and the bottom electrode layer 53 is positively charged, the white particles will float up and be gathered at the upper ends of the particle casings 56, and the black particles will sink and be gathered at the lower ends of the particle casings 56, thereby forming white display content at the top transparent electrode layer 51.

Due to the bistable characteristic, i.e. the hysteresis effect, of the transparent liquid, when the electric field between the top transparent electrode layer 51 and the bottom electrode layer 53 disappears, the color developing particles will also remain suspended at the positions at the moment of disappearance of the electric field. Therefore, the display content seen via the top transparent electrode layer 51 will also remain unchanged.

In Embodiment III, the color developing particle layer 52 is filled with transparent liquid. The color developing particles are formed by integrally connecting the positive-charge color developing particles 54 to the negative-charge color developing particles 55. One side of each color developing particle is the positive-charge color developing particle 54, and the opposite side is the negative-charge color developing particle 55. The color developing particles are suspended in the transparent liquid of the color developing particle layer 52.

If the top transparent electrode layer 51 is positively charged, and the bottom electrode layer 53 is negatively charged, the positive-charge color developing particles 54 are white, and the negative-charge color developing particles 55 are black. At this time, the black color developing particles rotate towards the top transparent electrode layer 51 until they face the top transparent electrode layer 51, and the white color developing particles rotate towards the bottom electrode layer 53 until they face the bottom electrode layer 53, thereby forming black display content at the top transparent electrode layer 51. On the contrary, if the top transparent electrode layer 51 is negatively charged, and the bottom electrode layer 53 is positively charged, the white color developing particles rotate towards the top transparent electrode layer 51, and the black color developing particles rotate towards the bottom electrode layer 53, thereby forming white display content at the top transparent electrode layer 51.

Due to the bistable characteristic, i.e. the hysteresis effect, of the transparent liquid, when the electric field between the top transparent electrode layer 51 and the bottom electrode layer 53 disappears, the color developing particles will also remain suspended at the positions at the moment of disappearance of the electric field. Therefore, the display content seen via the top transparent electrode layer 51 will also remain unchanged.

In this technical solution of the present disclosure, the color developing particles are suspended in the liquid with the hysteresis effect and can move to the corresponding positions under the action of an external electric field, thereby forming desired display content. After the electric field disappears, the hysteresis effect of the liquid can keep the positions of the color developing particles unchanged, so the display content can be maintained for long time. Even after the equipment is powered off, the display content is still clear and visible. This design significantly reduces the energy consumption by reducing the frequency of applying an electric field, and is especially suitable for low-energy-storage equipment, such as a smart ring, a smart bracelet, and a pair of smart glasses.

Both the positive-charge color developing particles 54 and the negative-charge color developing particles 55 can achieve an effect of not neutralizing and removing their own charges through the following modes:

Physical isolation: In many designs, positive- and negative-charge particles are packaged in tiny capsules. Each capsule contains liquid, and the positive- and negative-charge particles are suspended in the liquid. This microcapsule structure physically prevents the particles in different capsules from being in contact with and neutralizing each other.

Liquid medium: The particles are suspended in special liquid which is usually non-conductive. The viscosity and surface tension of the liquid help maintain particle dispersion and reduce the possibility of aggregation.

Surface treatment: Special treatment is performed on surfaces of the particles to form a stable charge layer. This surface treatment provides the particles with electrostatic repulsion, so that it is hard for the particles to neutralize even if the particles approach each other.

Size and density of the particles: The size and density of the particles are carefully designed to maintain a stable suspended state for the particles in the liquid. This reduces the chance of collision and contact between the particles.

Electric field control: During normal use, an external electric field is applied to controlling the movement of the particles. The presence of the electric field makes the particles more inclined to move towards the electrodes, rather than attracting each other.

Chemical stability: Chemical compositions of the particles have been optimized to maintain stability over long-term use. This chemical stability reduces the possibility of spontaneous discharge or neutralization of the particles.

Energy barrier: There is an energy barrier between the particles that needs to be overcome for occurrence of neutralization reactions. Under normal conditions, the particles do not have enough energy to overcome this potential barrier.

Hysteresis effect: The design of the color developing particle layer utilizes the hysteresis effect to keep the particles in a relatively stationary state without external force.

When the low-power display mechanism is applied to the low-energy-storage device, such as a smart ring, the smart ring includes a shell 1. The shell 1 is provided with a perspective window 11. The low-power display screen 5 is arranged at the perspective window 11. The circuit board assembly 3 and the storage battery 4 are arranged on an inner side of the shell 1. The circuit board assembly 3 includes a flexible printed circuit board 31. The flexible printed circuit board 31 is packaged with a charging interface 32 and an electronic component 33. A potting adhesive layer 2 is arranged on an inner side of the shell 1. The circuit board assembly 3, the storage battery 4, and the low-power display screen 5 are all packaged in the potting adhesive layer 2. The charging interface 32 extends out of the potting adhesive layer 2. The low-power display screen 5 displays corresponding content according to a control instruction under the control of the built-in control chip in the circuit board assembly 3 of the smart ring. The display content is displayed to a user from the perspective window 11 on the shell 1, and can be intermittently switched through a software setting control circuit. Since the low-power display screen 5 only consumes electricity at the moment of switching the display content, and will not consume electricity in a standby state. Therefore, the display content is switched using an intermittent mode, so that the power consumption is very low. When the charging interface 32 is connected to an external power supply through a charging cable, the storage battery 4 can be charged to supplement electric energy.

In summary: In the present disclosure, the low-power display screen 5 only consumes electricity when changing display content, and the display content can be maintained for long time and will not disappear even if there is a power outage. Furthermore, the display content can be clear and visible under strong light. The design significantly reduces the energy consumption by reducing the frequency of applying an electric field, and is suitable for being used in various low-energy-storage devices.

It should be noted that in this document, relationship terms such as first and second are used solely to distinguish one entity or operation from another entity or operation without necessarily requiring or implying any actual such relationship or order between such entities or operations. Furthermore, the terms “include”, “including”, or any other variation thereof, are intended to encompass a non-exclusive inclusion, such that a process, method, article, or device that includes a list of elements does not include only those elements but may include other elements not explicitly listed or inherent to such process, method, article, or device.

Although the embodiments of the present disclosure have been shown and described, it can be understood by those of ordinary skill in the art that various changes, modifications, substitutions, and variations can be made to these embodiments without departing from the principle and spirit of the present disclosure. The scope of the present disclosure is defined by the accompanying claims and their equivalents.

What is claimed is:

1. A low-power display mechanism applied to a low-energy-storage device, comprising a circuit board assembly (3), a storage battery (4), and a low-power display screen (5), wherein the storage battery (4) and the low-power display screen (5) are both electrically connected to the circuit board assembly (3); the low-power display screen (5) comprises a top transparent electrode layer (51), a color developing particle layer (52), and a bottom electrode layer (53); the color developing particle layer (52) is sandwiched between the top transparent electrode layer (51) and the bottom electrode layer (53); the color developing particle layer (52) is provided with a plurality of color developing particles; the color developing particles have own charges; the color developing particles comprise positive-charge color developing particles (54) and negative-charge color developing particles (55); colors between the positive-charge color developing particles (54) and the negative-charge color developing particles (55) are different; and when an electric field is applied to a sandwich region between the top transparent electrode layer (51) and the bottom electrode layer (53), the color developing particles are driven by the electric field to be transferred towards an opposite electric field direction corresponding to the color developing particles.

2. The low-power display mechanism applied to the low-energy-storage device according to claim 1, wherein liquid with a hysteresis effect is packaged in the color developing particle layer (52), and the color developing particles are suspended in the liquid of the color developing particle layer (52).

3. The low-power display mechanism applied to the low-energy-storage device according to claim 1, wherein the color developing particle layer (52) is filled with a plurality of particle casings (56); the color developing particles are wrapped by the particle casings (56); the positive-charge color developing particles (54) and the negative charge color developing particles (55) coexist in the particle casings (56); liquid with a hysteresis effect is packaged in the particle casings (56); and the positive-charge color developing particles (54) and the negative charge color developing particles (55) are suspended in the liquid in the particle casings (56).

4. The low-power display mechanism applied to the low-energy-storage device according to claim 3, wherein the particle casings (56) are transparent casings.

5. The low-power display mechanism applied to the low-energy-storage device according to claim 1, wherein the color developing particles are formed by integrally connecting the positive-charge color developing particles (54) to the negative-charge color developing particles (55); one side of each color developing particle is the positive-charge color developing particle (54), and the opposite side is the negative-charge color developing particle (55); liquid with a hysteresis effect is packaged in the color developing particle layer (52); and the color developing particles are suspended in the liquid of the color developing particle layer (52).

6. The low-power display mechanism applied to the low-energy-storage device according to claim 2, wherein the liquid is transparent liquid.

7. The low-power display mechanism applied to the low-energy-storage device according to claim 1, wherein the bottom electrode layer (53) is a segment code electrode layer; the segment code electrode layer is composed of a plurality of electrodes (6) arranged in pre-defined segments to form display content; and each segmented electrode (6) is independently controlled.

8. The low-power display mechanism applied to the low-energy-storage device according to claim 1, wherein the bottom electrode layer (53) is a dot matrix electrode layer; the dot matrix electrode layer comprises a thin film transistor (TFT) substrate layer for supporting and a thin film transistor layer that covers the TFT substrate layer; a plurality of pixel electrodes (6) are arranged in a dot matrix on the TFT substrate layer; a transistor is correspondingly connected to each pixel electrode (6); and display content is formed by controlling a transistor dot matrix.

9. The low-power display mechanism applied to the low-energy-storage device according to claim 1, wherein the low-energy-storage device is a smart ring; the smart ring comprises a shell (1); the shell (1) is provided with a perspective window (11); the low-power display screen (5) is arranged at the perspective window (11); the circuit board assembly (3) and the storage battery (4) are arranged on an inner side of the shell (1); the circuit board assembly (3) comprises a flexible printed circuit board (31); and the flexible printed circuit board (31) is packaged with a charging interface (32) and an electronic component (33).

10. The low-power display mechanism applied to the low-energy-storage device according to claim 9, wherein a potting adhesive layer (2) is arranged on an inner side of the shell (1); the circuit board assembly (3), the storage battery (4), and the low-power display screen (5) are all packaged in the potting adhesive layer (2); and the charging interface (32) extends out of the potting adhesive layer (2).
